(19) United States
(12) Patent Application Publication
(10) Pub. No.: US 2025/0206979 A1
(43) Pub. Date: Jun. 26, 2025

(54) CURABLE COMPOSITION AND COATED SUPERSTRATE

(71) Applicant: CANON KABUSHIKI KAISHA, Tokyo (JP)

(72) Inventors: Kui XU, Austin, TX (US); Weijun LIU, Cedar Park, TX (US); Timothy Brian STACHOWIAK, Austin, TX (US); Fen WAN, Austin, TX (US)

(21) Appl. No.: 18/396,114

(22) Filed: Dec. 26, 2023

(51) Int. Cl. C09D 163/00; B05D 1/00; C08L 63/00; C09D 7/20

(52) U.S. Cl. CPC C09D 163/00; B05D 1/005; C08L 63/00; C09D 7/20; B05D 2401/10; B05D 2504/00; C08L 2201/56; C08L 2205/02; C08L 2205/05

(57) ABSTRACT

A curable composition can comprise a first alkyl-acrylate polymer (AAP1) consisting essentially of the elements carbon, hydrogen, and oxygen; a second alkyl-acrylate polymer (AAP2) consisting essentially of the elements carbon, hydrogen, oxygen, and fluorine; a thermal acid generator; and a solvent, wherein a weight percent ratio of AAP1 to AAP2 is at least 2:1. The curable composition can be used for coating a superstrate blank to form a coated superstrate having excellent hydrophobic surface properties.

### FIELD OF THE DISCLOSURE

The present disclosure relates to a curable composition and a superstrate coated with the curable composition for Inkjet Adaptive Planarization.

### BACKGROUND

Inkjet Adaptive Planarization (IAP) requires the use of a superstrate having a high flatness and a super-hydrophobic and super-oleophobic working surface. Such working surfaces can comprise a polymeric layer applied by spin-coating, wherein the polymeric layer contains as majority a perfluorinated polymer. Because of the high material costs and technical challenges of handling perfluorinated polymers, an intermediate layer is often included underneath the perfluorinated layer. Other disadvantages of using perfluorinated polymers as coating material are the limited solubility of these polymers in non-fluorinated solvents (non-fluorinated solvents being desired because of their low costs), as well as problems during filtering at filter pore sizes in the range of 10 nm and below.

There exists a need to improve spin-coated superstrates, wherein the hydrophobic coating layer has low material costs and allows simplified and efficient handling, such as improved solubility in low-cost solvents, easy processability, and less environmental concerns.

### SUMMARY

In one embodiment, a superstrate can comprise a first alkyl-acrylate polymer (AAP1) consisting essentially of the elements carbon, hydrogen, and oxygen; a second alkyl-acrylate polymer (AAP2) consisting essentially of the elements carbon, hydrogen, oxygen, and fluorine; a thermal acid generator; and a solvent, wherein a weight percent ratio of AAP1 to AAP2 is at least 2:1.

In one aspect, the weight percent ratio of AAP1 to AAP2 of the curable composition can be at least 10:1, in another aspect, the weight percent ratio may be at least 30:1.

In another embodiment of the curable composition, the second alkyl-acrylate polymer (AAP2) can comprise perfluoro alkyl groups, or partially fluorinated alkyl groups, or a combination thereof. In a certain aspect, both the first alkyl-acrylate polymer (AAP1) and the second alkyl-acrylate polymer (AAP2) can comprise glycidyl groups.

In a further embodiment of the curable composition, the second alkyl-acrylate polymer (AAP2) can be a polymerization product of a perfluoro-alkyl-acrylate and glycidyl (meth)acrylate, or a polymerization product of a partially fluorinated alkyl-acrylate and glycidyl (meth)acrylate. In a particular aspect, the second alkyl-acrylate polymer (AAP2) can be a polymerization product of perfluoro-butyl ethyl methacrylate and glycidyl methacrylate.

In one embodiment of the curable composition, the amount of the first alkyl-acrylate polymer (AAP1) can be at least 0.1 wt % and not greater than 40 wt % based on the total weight of the curable composition.

In another embodiment, the amount of the second alkyl-acrylate polymer (AAP2) can be at least 0.01 wt % and not greater than 20 wt % based on the total weight of the curable composition.

In yet a further embodiment of the curable composition, the amount of the solvent can be at least 50 wt % based on the total weight of the curable composition.

In one aspect, the solvent can include ethyl acetoacetate, toluene, ethyl lactate, cyclohexanone, propylene glycol methyl ether acetate, butyrolactone, xylene, dimethylformamide, or dimethylacetamide.

In a further aspect, viscosity of the curable composition may be not greater than 200 mPa·s at a temperature of 23° C.

In another embodiment of the present disclosure, a coated superstrate can comprise: a superstrate blank having a first surface and a second surface, the first surface and the second surface being opposite to each other; a solid polymeric layer directly overlying the first surface of the superstrate blank, wherein the solid polymeric layer is a cured coating of a curable composition, the curable composition comprising a first alkyl-acrylate polymer consisting essentially of the elements carbon, hydrogen, and oxygen; a second alkyl-acrylate polymer consisting essentially of the elements carbon, hydrogen, oxygen, and fluorine; a thermal acid generator; and a solvent, wherein a weight percent ratio of the first alkyl-acrylate polymer to the second alkyl-acrylate polymer is at least 2:1, and wherein a water contact angle of the solid polymeric layer can be at least 95°.

In one aspect of the coated superstrate, the weight percent ratio of the first alkyl-acrylate polymer (AAP1) to the second alkyl-acrylate polymer (AAP2) of the curable composition can be at least 10:1.

In another aspect of the coated superstrate, the second alkyl-acrylate (AAP2) can be a polymerization product of a perfluoro-alkyl methacrylate and glycidyl methacrylate, or of a partially fluorinated alkyl methacrylate and glycidyl methacrylate.

In one aspect of the coated superstrate, a weight % amount of the fluorine in the solid polymeric layer can be at least 0.01 wt % and not greater than 25 wt % based on the total weight of the polymeric layer.

In another aspect of the coated superstrate, the thickness of the solid polymeric layer can be at least 0.005 microns and not greater than 10 microns.

In one embodiment, a system for planarizing a formable material can comprise the above-described coated superstrate coupled to a superstrate holder; and a formable material positioned on a substrate, wherein the coated superstrate is positioned above a top surface of the formable material and may be configured for planarizing the top surface of the formable material.

In another embodiment, a method of forming a coated superstrate can comprise: providing a superstrate blank having a first surface and a second surface, the first surface being opposite to the second surface; applying on the first surface of the superstrate blank a liquid layer of a curable composition, the curable composition including a first alkyl-acrylate polymer (AAP1) consisting essentially of the elements carbon, hydrogen, and oxygen; a second alkyl-acrylate polymer (AAP2) consisting essentially of the elements carbon, hydrogen, oxygen, and fluorine; a thermal acid generator; and a solvent, and wherein a weight percent ratio of AAP1 to AAP2 is at least 2:1; and curing the curable composition to form the solid polymeric layer, wherein the solid polymeric layer has a water contact angle of at least 95°.

In one aspect of the method, the curable composition can be applied on the first surface of the core body by spin-coating.

### BRIEF DESCRIPTION OF THE DRAWINGS

Embodiments are illustrated by way of example and are not limited in the accompanying figure.

FIG. 1 includes a line drawing illustrating a section of a side-view of a coated superstrate according to one embodiment.

FIG. 2 includes a line drawing illustrating a system for planarizing a formable material including a coated superstrate according to one embodiment.

Skilled artisans appreciate that elements in the figures are illustrated for simplicity and clarity and have not necessarily been drawn to scale. For example, the dimensions of some of the elements in the figures may be exaggerated relative to other elements to help improve understanding of embodiments of the invention.

### DETAILED DESCRIPTION

The following description is provided to assist in understanding the teachings disclosed herein and will focus on specific implementations and embodiments of the teachings. This focus is provided to assist in describing the teachings and should not be interpreted as a limitation on the scope or applicability of the teachings.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the imprint and lithography arts.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The present disclosure is directed to a curable composition comprising a first alkyl-acrylate polymer (AAP1) consisting essentially of the elements carbon, hydrogen, and oxygen; a second alkyl-acrylate polymer (AAP2) consisting essentially of the elements carbon, hydrogen, oxygen, and fluorine; a thermal acid generator; and a solvent, wherein a weight percent ratio of AAP1 to AAP2 can be at least 2:1.

As used herein, the term “alkyl-acrylate polymer” can relate to a homopolymer or a copolymer. Furthermore, the term “alkyl-acrylate” also includes a substituted alkyl-acrylate, for example, an alkyl methacrylate.

It has been surprisingly found that the curable composition of the present disclosure is suitable for forming a solid polymeric layer on a superstrate which can be a very cost-efficient replacement of expensive super-hydrophobic and super oleophobic fluoropolymer coatings, such as, for example, Cytop.

In one embodiment, the ratio of AAP1 to AAP2 can be at least 2:1, or at least 4:1, or at least 5:1, or at least 10:1, or at least 15:1, or at least 20:1, or at least 25:1, or at least 30:1, or at least 35:1, or at least 40:1, or at least 50:1, or at least 60:1, or at least 70:1, or at least 80:1. In another aspect, the ratio of the first alkyl-acrylate polymer to the second alkyl(meth)acrylate polymer may be not greater than 150:1, or not greater than 100:1.

In one aspect, AAP1 and AAP2 can contain functional groups which allow cross-linking reactions with each other during curing. In a specific aspect, the functional groups can be glycidyl groups, or hydroxyl groups, or carboxylic acid groups, or alkoxysilane groups, or vinyl groups, or acrylate groups. In a particular specific aspect, both AAP1 and AAP2 can comprise glycidyl groups.

As used herein, the phrase “a first alky-acrylate polymer (AAP1) consisting essentially of carbon, hydrogen, and oxygen” means that the amount of other elements next to carbon, hydrogen and oxygen, is not greater than 0.5 wt % based on the total weight of the AAP1, or not greater than 0.3 wt %, or not greater than 0.1 wt %.

Furthermore, as used herein, the phrase “a second alkyl-acrylate polymer (AAP2) consisting essentially of carbon, hydrogen, oxygen, and fluorine” means that the amount of other elements next to carbon, hydrogen, oxygen, and fluorine, is not greater than 0.5 wt % based on the total weight of the AAP2, or not greater than 0.3 wt %, or not greater than 0.1 wt %.

In one embodiment, the second alkyl-acrylate polymer (AAP2) can be a polymerization product of a perfluoro-alkyl-acrylate and a glycidyl-acrylate, or a polymerization product of a partially fluorinated alkyl-acrylate and a glycidyl-acrylate.

As used herein, the term glycidyl-acrylate includes also a substituted glycidyl-acrylate, for example, glycidyl methacrylate.

In a particular aspect, the AAP2 can be a polymerization product of perfluoro-butyl ethyl methacrylate and glycidyl methacrylate.

In another embodiment, the AAP1 can be a copolymer formed from an alkyl-acrylate and a glycidyl-acrylate. In a particular aspect, the AAP1 can be a copolymer formed from methyl methacrylate and glycidyl methacrylate.

In one aspect, the molecular weight of the AAP1 can be at least 1000 g/mol, or at least 5000 g/mol, or at least 10,000 g/mol, or at least 20,000 g/mol, or at least 50,000 g/mol, or at least 100,000 g/mol, or at least 200,000 g/mol, or at least 500,000 g/mol. In another aspect, the molecular weight of the AAP1 may be not greater than 1,000,000 g/mol, or not greater than 800,000 g/mol, or not greater than 500,000 g/mol, or not greater than 100,000 g/mol, or not greater than 50,000 g/mol.

In a further aspect, the molecular weight of the AAP2 can be at least 1000 g/mol, or at least 5000 g/mol, or at least 10,000 g/mol, or at least 20,000 g/mol, or at least 50,000 g/mol, or at least 100,000 g/mol, or at least 200,000 g/mol, or at least 500,000 g/mol. In another aspect, the molecular weight of the AAP1 may be not greater than 1,000,000 g/mol, or not greater than 800,000 g/mol, or not greater than 500,000 g/mol, or not greater than 100,000 g/mol, or not greater than 50,000 g/mol.

In a further embodiment, the amount of the first alkyl-acrylate polymer (AAP1) can be at least 0.1 wt % based on the total weight of the curable composition, or at least 0.5 wt %, or at least 1 wt %, or at least 3 wt %, or at least 5 wt %, or at least 8 wt %, or at least 10 wt %, or at least 15 wt %, or at least 20 wt %. In another aspect, the amount of the AAP1 may be not greater than 40 wt %, or not greater than 30 wt %, or not greater than 20 wt %, or not greater than 15 wt %, or not greater than 10 wt %.

In another embodiment, the amount of the second alkyl-acrylate polymer (AAP2) may be at least 0.01 wt % based on the total weight of the curable composition, or at least 0.05 wt %, or at least 0.08 wt %, or at least 0.1 wt %, or at least 0.2 wt %, or at least 0.5 wt %, or at least 1.0 wt %, or at least 2.0 wt %. In yet a further aspect, the amount of the AAP2 may be not greater than 10 wt %, or not greater than 5 wt %, or not greater than 3 wt %, or not greater than 1 wt % based on the total weight of the curable composition.

The amount of the solvent in the curable composition can be at least 50 wt % based on the total weight of the curable composition, or at least 60 wt %, or at least 70 wt % or at least 80 wt %, or at least 85 wt %, or at least 90 wt %, or at least 92 wt %, or at least 95 wt %. In one aspect, the amount of the solvent may be not greater than 99 wt %, or not greater than 97 wt %, or not greater than 95 wt %, or not greater than 93 wt %, or not greater than 90 wt %, or not greater than 85 wt % based on the total weight of the curable composition.

Non-limiting examples of suitable solvents of the curable composition can be ethyl acetoacetate, toluene, ethyl lactate, cyclohexanone, propylene glycol methyl ether acetate, butyrolactone, xylene, dimethylformamide, or dimethylacetamide. In a particular aspect, the solvent can include ethyl acetoacetate.

In one embodiment, before coating the superstrate blank with the curable composition of the present disclosure, the curable composition can be filtered through a filter having a pore size of not greater than 0.1 microns, or not greater than 0.05 microns, or not greater than 0.02 microns, or not greater than 0.01 microns.

In one aspect, the curable composition of the present disclosure can be essentially free of particles, for example being essentially free of pigment particles. As used herein, being essentially free of particles means that the curable composition contains not more than 50 particles per ml having a size of 200 nm or greater, or not more than 50 particles per ml having a size of 150 nm or greater, or not more than 50 particles per ml having a size of 100 nm or greater, or not more than 50 particles per ml having a size of 50 nm or greater.

In yet a further embodiment, the curable composition of the present disclosure may not include epoxide-group containing monomers, or epoxy-group containing oligomers, or acrylamides, or a polyurethane.

In another embodiment, the viscosity at 23° C. of the curable composition can be not greater than 200 mPa·s, or not greater than 150 mPa·s, or not greater than 100 mPa·s, or not greater than 50 mPa·s, or not greater than 40 mPa·s, or not greater than 30 mPa·s, or not greater than 25 mPa·s, or not greater than 20 mPa·s, or not greater than 15 mPa·s, or not greater than 12 mPa·s, or not greater than 10 mPa·s. In another aspect, the coating composition can have a viscosity of at least 2 mPa·s, or at least 4 mPa·s, or at least 6 mPa·s. As used herein, the viscosities relate to Brookfield viscosities, measured with a Brookfield viscometer at 23° C.

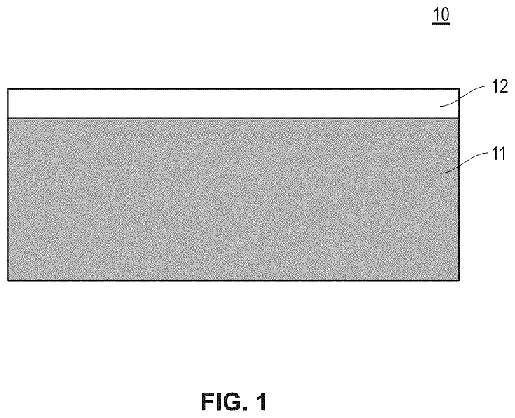

FIG. 1 includes an illustration of a side view of a coated superstrate (10), containing a superstrate blank (11) and a solid polymeric layer (12) directly overlying the superstrate blank (11).

In one embodiment, the solid polymeric layer (12) can include a polymerization product of the first alkyl-acrylate polymer (AAP1) consisting essentially of the elements carbon, hydrogen, and oxygen; and the second alkyl-acrylate polymer (AAP2) consisting essentially of the elements carbon, hydrogen, oxygen, and fluorine.

In one embodiment, the solid polymeric layer (12) can be formed by applying a liquid layer of the above-described curable composition of the present disclosure via spin-coating on the superstrate blank (11). The liquid layer can be cured by heating the coated superstrate in the presence of a thermal acid generator.

In one aspect, the curing temperature can be at least 80° C., or at least 100° C., or at least 130° C., or at least 150° C., or at least 180° C. In another aspect, the curing temperature may be not greater than 300° C., or not greater than 250° C.

The amount of the thermal acid generator in the curable composition can be at least 0.00001 wt % based on the total weight of the curable composition, or at least 0.0001 wt %, or at least 0.001 wt %, or at least 0.01 wt %, or at least 0.1 wt %. In one aspect, the amount of the thermal acid generator may be not greater than 0.5 wt % based on the total weight of the curable composition, or not greater than 0.1 wt %, or not greater than 0.05 wt %.

Non-limiting examples of a thermal acid generator can be triarylsulfonium salts, or dialkylphenylsulfonium salts, or diazeniumdiolates, or sulfonate esters, or ketoxime esters, or imides, or N-sulfonyloxaziridines, or benzoin ethers, or sulfonylhydrazides.

In a certain aspect, an average thickness of the solid polymeric layer (12) can be at least 0.005 microns, or at least 0.010 microns, or at least 0.020 microns, or at least 0.050 microns, or at least 0.1 microns, or at least 0.2 microns, or at least 0.3 microns, or at least 0.5 microns, or at least 1 micron. In another aspect, the average thickness of the solid polymeric layer may be not greater than 10 microns, or not greater than 5 microns, or not greater than 2 microns, or not greater than 1 micron, or not greater than 0.5 microns.

The solid polymeric layer can include a polymerization product of the first alkyl-acrylate polymer (AAP1) consisting essentially of the elements carbon, hydrogen, and oxygen; and the second alkyl-acrylate polymer (AAP2) consisting essentially of the elements carbon, hydrogen, oxygen, and fluorine.

In a further embodiment, the superstrate blank can be made from a variety of materials. Non-limiting examples of materials can include a glass-based material, silicon, a spinel, a fused-silica, quartz, an organic polymer, a fluorocarbon polymer, or any combination thereof. The glass-based material can include soda lime glass, borosilicate glass, alkali-barium silicate glass, quartz glass, aluminosilicate glass, or synthetic fused-silica.

In a particular aspect, the coated superstrate can be transparent to a selected actinic radiation used for curing a formable material, for example, to cure a resist during planarization at a certain UV light wave range.

In a certain embodiment, the coating (12) can be a single-layer coating. In another certain embodiment, the coating can be a multi-layer coating.

It has been surprisingly found that curable compositions containing only a minor amount of AAP2 can lead to cured polymeric layers (12) having an excellent hydrophobicity. In one embodiment, the water contact angle of the solid polymeric layer (12) can be at least 95°, or at least 98°, or at least 100°, or at least 102°. In a further aspect, the water contact angle may be not greater than 140°.

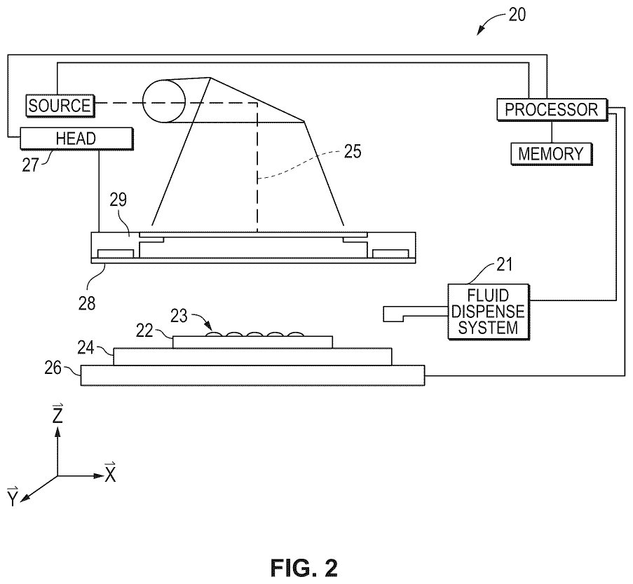

Referring to FIG. 2, a system (20) in accordance with an embodiment described herein can be used to planarize a formable material (23) on a substrate (22) using the coated superstrate (28) of the present disclosure. The coated superstrate (28) can be positioned spaced-apart from the substrate (22).

The substrate (22) may be coupled to a substrate holder (24), for example, to a chuck. The chuck may be any chuck including vacuum, pin-type, groove-type, electrostatic, electromagnetic, or the like. The substrate (22) and substrate holder (24) may be further supported by a stage (26). The stage (26) may provide translating or rotational motion along the X-, Y-, or Z-directions.

The coated superstrate (28) can be used to planarize a formable material deposited on a substrate (22). The coated superstrate (28) can be coupled to a superstrate holder (29). The coated superstrate (28) may be both held by and its shape modulated by the superstrate holder (29). The superstrate holder (29) may be configured to hold the superstrate (28) within a chucking region. The superstrate holder (29) can be configured as vacuum, pin-type, groove-type, electrostatic, electromagnetic, or another similar holder type. In one embodiment, the superstrate holder (29) can include a transparent window within the body of the superstrate holder (29).

The system (20) can further include a fluid dispense system (21) for depositing a formable material (23) on the surface of the substrate (22). The formable material (23) can be positioned on the substrate (22) in one or more layers using techniques such as droplet dispense, spin-coating, dip coating, chemical vapor deposition (CVD), physical vapor deposition (PVD), thin film deposition, thick film deposition, or combinations thereof. The formable material (23) can be dispensed upon the substrate (22) before or after a desired volume is defined between the superstrate (28) and the substrate (22). The formable material (23) can include one or more polymerizable monomers and/or oligomers and/or polymers that can be cured using actinic radiation and/or heat.

As further demonstrated in the examples, it has been discovered that a cost-efficient coated superstrate can be made having a high hydrophobicity by using a curable composition containing the polymers AAP1 and AAP2 in a ratio of at least 2:1.

### EXAMPLES

The following non-limiting examples illustrate the concepts as described herein.

### Example 1

### Coating Components:

X-PMMA 230A: A copolymer made in-house, which was made by combining 92.5 mol % methyl methacrylate (MMA) and 7.5 mol % glycidyl methacrylate (GMA).

PFMA-2: A copolymer made in-house, which was made by combining 75 mol % perfluoro-butyl ethyl methacrylate (PFBEMA) and 25 mol % glycidylmethacrylate (GMA).

TAG2678: Is a thermal acid generator from King Industries, Inc.

### Preparation of Curable Compositions

A series of curable compositions was prepared by combining different ratios of X-PMMA 230A and PFMA-2 in the solvent ethylacetoacetate. Each composition contained 0.04 wt % of the thermal acid generator TAG2678. The compositions were stirred at room temperature (23° C.) overnight and thereafter filtered through an 0.1 micron pore size PTFE filter. The viscosity of the compositions after filtering was between 2 mPa·s and 25 mPa·s measured with the Brookfield method.

The coating layers were prepared by applying 8 ml of the curable compositions on a silicon wafer having a diameter of 200 mm via spin-coating using a Cee® Spin Coater at a rotation speed of 1500 rpm for 60 seconds. Thereafter, the applied coating was cured at 180° C. for 180 seconds.

A summary of the coating compositions, the measured thicknesses of the formed solid layers after curing and the measured water contact angle is shown in Table 1.

It can be seen that already a minor amount of only 0.1 wt PFMA-2 in the curable composition in combination with 8 wt % of XPMMA was sufficient to form cured layers having a water contact angle very similar to the water contact angle of a layer formed with PFMA-2 alone (see comparative sample C2). The difference in water contact angle was only about 2 degrees. In contrast, a layer formed from a curable composition containing only the fluorine-free copolymer XPMMA had an about 37 degrees lower water contact angle (comparative sample C1), while a curable composition containing 0.01 wt % of perfluoropolymer PFMA-2 led and 8 wt % XPMMA led to layers having an about 18 degrees lower water contact angle (sample C3) in comparison to sample C2.

TABLE 1

| | | XPMMA | | Contact | Contact | Contact |
|---|---|---|---|---|---|---|
| | PFMA-2 | 2304A | Thickness | Angle [°] | Angle [°] | Angle [°] |
| Sample | [wt %] | [wt %] | [nm] | Water | (IAP resist-1) | (IAP resist - 2) |
| S1 | 1 | 8 | 313 | 105.15 | 69.01 | 75.04 |
| S2 | 1.5 | 8 | 344 | 104.87 | 68.91 | 74.23 |
| S3 | 0.5 | 8 | 307 | 105.18 | 69.59 | 74.69 |
| S4 | 0.25 | 8 | 292 | 104.67 | 69.24 | 74.53 |
| S5 | 0.10 | 8 | 276 | 103.30 | 67.17 | 72.69 |
| S6 | 0.5 | 4 | 150 | 105.68 | 69.43 | 74.77 |
| C1 | | 8 | 298 | 68.74 | 9.73 | 10.18 |
| C2 | 1 | | 17.5 | 105.54 | 69.47 | 75.41 |
| C3 | 0.01 | 8 | 266 | 87.7 | 41.9 | 51.7 |

The contact angle was also measured using instead of water two different liquid resists, called herein IAP resist-1 and IAP resist-2. IAP resist-1 contained about 95 wt % of multifunctional acrylate monomers; while IAP resist-2 contained about 95 wt % of multi-functional styrenic monomers. For both resist types the same pattern was observed as with water: The resist contact angles to solid polymeric layers containing low amounts of the perfluoropolymer (samples S1 to S5) were very close to the contact angle of a solid polymeric layer formed only with the PFMA-2 (sample C2). Even low amounts of 0.1 wt % PFMA-2 in the curable composition resulted in cured polymeric layers having only a minor change in the contact angle of not more than 2.5-3.0 degrees.

It was surprising that curable compositions containing very low amounts of the fluorine-containing copolymer PFMA-2 in combination with a fluorine-free acrylate copolymer could be easily handled and spin-coated directly on the wafers, and cured by using a thermal acid generator to polymeric solid layers having excellent hydrophobic properties.

### Measuring the Contact Angle

The contact angle was measured with a Drop Master DM-701 contact angle meter made by Kyowa Interface Science Co. Ltd. (Japan).

For the testing, 2 ml of deionized water (or IAP resist) was added to the syringe, of which 2 μl sample per test was added by the machine to the surface of the coated and cured wafer. Drop images were continuously captured by a CCD camera from the time the resist sample drop touched the layer surface. The contact angle was automatically calculated by the software based on the analysis of the images. The data presented in Table 1 are the contact angles at a time of 3 seconds after touching the surface of the wafer coating.

### Measuring the Viscosity

The viscosities of the curable compositions were measured using a Brookfield Viscometer LVDV-II+Pro at 200 rpm, with a spindle size #18 and a spin speed of 135 rpm. For the viscosity testing, about 6-7 mL of sample liquid was added into the sample chamber, enough to cover the spindle head. The sample contained in the chamber was about 20 minutes equilibrated to reach the desired measuring temperature of 23° C. before the actual measurement was started. For all viscosity testing, at least three measurements were conducted and an average value was calculated.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any sub combination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A curable composition comprising:
a first alkyl-acrylate polymer (AAP1) consisting essentially of the elements carbon, hydrogen, and oxygen;
a second alkyl-acrylate polymer (AAP2) consisting essentially of the elements carbon, hydrogen, oxygen, and fluorine;
a thermal acid generator; and
a solvent,
wherein a weight percent ratio of AAP1 to AAP2 is at least 2:1.

2. The curable composition of claim 1, wherein the weight percent ratio of AAP1 to AAP2 is at least 10:1.

3. The curable composition of claim 2, wherein the weight percent ratio of AAP1 to AAP2 is at least 30:1.

4. The curable composition of claim 1, wherein the second alkyl-acrylate polymer (AAP2) comprises perfluoro alkyl groups, or partially fluorinated alkyl groups, or a combination thereof.

5. The curable composition of claim 1, wherein both the first alkyl-acrylate polymer (AAP1) and the second alkyl-acrylate polymer (AAP2) comprise glycidyl groups.

6. The curable composition of claim 1, wherein the second alkyl-acrylate (AAP2) is a polymerization product of a perfluoro-alkyl methacrylate and glycidyl methacrylate, or of a partially fluorinated alkyl methacrylate and glycidyl methacrylate.

7. The curable composition of claim 6, wherein the second alkyl-acrylate polymer (AAP2) is a polymerization product of perfluoro-butyl ethyl methacrylate and glycidyl methacrylate.

8. The curable composition of claim 1, wherein an amount of the first alkyl-acrylate polymer (AAP1) is at least 0.1 wt % and not greater than 40 wt % based on the total weight of the curable composition.

9. The curable composition of claim 1, wherein an amount of the second alkyl-acrylate polymer (AAP2) is at least 0.01 wt % and not greater than 10 wt % based on the total weight of the curable composition.

10. The curable composition of claim 1, wherein an amount of the solvent is at least 50 wt % based on the total weight of the curable composition.

11. The curable composition of claim 1, wherein the solvent includes ethyl acetoacetate, toluene, ethyl lactate, cyclohexanone, propylene glycol methyl ether acetate, butyrolactone, xylene, dimethylformamide, or dimethylacetamide.

12. The curable composition of claim 1, wherein a viscosity of the curable composition is not greater than 200 mPa·s at 23° C.

13. A coated superstrate comprising:
a superstrate blank having a first surface and a second surface, the first surface and the second surface being opposite to each other;
a solid polymeric layer directly overlying the first surface of the superstrate blank, wherein the solid polymeric layer is a cured coating layer of a curable composition, the curable composition comprising a first alkyl-acrylate polymer (AAP1) consisting essentially of the elements carbon, hydrogen, and oxygen; a second alkyl-acrylate (AAP2) polymer consisting essentially of the elements carbon, hydrogen, oxygen, and fluorine; a thermal acid generator; and a solvent, wherein a weight percent ratio of AAP1 to AAP2 is at least 2:1, and
wherein a water contact angle of the solid polymeric layer is at least 95°.

14. The coated superstrate of claim 13, wherein the weight percent ratio of the first alkyl-acrylate polymer to the second alkyl-acrylate polymer is at least 10:1.

15. The coated superstrate of claim 13, wherein the second alkyl-acrylate (AAP2) is a polymerization product of a perfluoro-alkyl methacrylate and glycidyl methacrylate, or a partially fluorinated alkyl methacrylate and glycidyl methacrylate.

16. The coated superstrate of claim 13, wherein a weight % amount of fluorine in the solid polymeric layer is at least 0.01 wt % and not greater than 25 wt % based on the total weight of the polymeric layer.

17. The coated superstrate of claim 13, wherein a thickness of the solid polymeric layer is at least 0.005 microns and not greater than 10 microns.

18. A system for planarizing a formable material, comprising:
the coated superstrate of claim 13 coupled to a superstrate holder; and
a formable material positioned on a substrate,
wherein the coated superstrate is positioned above a top surface of the formable material and configured for planarizing the top surface of the formable material.

19. A method of forming a coated superstrate, comprising:
providing a superstrate blank having a first surface and a second surface, the first surface being opposite to the second surface;
applying on the first surface of the superstrate blank a liquid layer of a curable composition, the curable composition including a first alkyl-acrylate polymer (AAP1) consisting essentially of the elements carbon, hydrogen, and oxygen; a second alkyl-acrylate polymer (AAP2) consisting essentially of the elements carbon, hydrogen, oxygen, and fluorine; a thermal acid generator; and a solvent, and wherein a weight percent ratio of AAP1 to AAP2 is at least 2:1; and
curing the curable composition to form the solid polymeric layer,
wherein the solid polymeric layer has a water contact angle of at least 95°.

20. The method of claim 18, wherein the curable composition is applied on the first surface of the core body by spin-coating.
